(19) United States
(12) Patent Application Publication
(10) Pub. No.: US 2009/0084692 A1
(43) Pub. Date: Apr. 2, 2009

(54) Method and device for preparation of a container containing a heated liquid of proper temperature

(76) Inventor: Melissa J. Fernandez, Santa Barbara, CA (US)

Correspondence Address: M. Reza Savari, Esq., 7668 Frederiksen Lane, Dublin, CA, 94568, US

(21) Appl. No.: 11/904,853

(22) Filed: Sep. 29, 2007

(51) Int. Cl. G01K 11/12; B65D 71/00; G01K 13/00

(52) U.S. Cl. 206/217; 29/428; 374/150

(57) ABSTRACT

The present invention relates generally to the field of methods, devices, and kits for preparation of a baby bottle, cup, mug, or the like containing a heated liquid having a proper temperature for infants, and particularly to methods and devices including a thermochromatic ink that changes color above the comfort zone of the infant. The present invention is particularly adaptable as an addition to any baby bottle of evaluation of the temperature of the heated liquid inside the baby bottle before feeding the infant.

### FIELD OF INVENTION

The present invention relates generally to the field of methods and devices for preparation of a baby bottle, cup, mug, or the like containing a heated liquid having a proper temperature, and particularly to methods and devices including a thermochromatic ink that changes color above the comfort zone of the infant.

### BACKGROUND OF THE INVENTION

Most infants are fed from a bottle at some point in their life. This is true even of breast fed babies when the baby may have to be separated from her mother due to work schedules, visitation schedules, illness of the mother, or a child that prevents breast feeding. The bottle feeding period can range anywhere from birth up through toddler age. The purpose of the bottle is simply to provide nourishment and hydration to a child who cannot or does not eat solid food, or cannot drink from a cup or sippy cup.

A variety of baby bottles are commercially available. Bottles currently on the market are comprised of a plastic, cylindrical container portion much like a cup, and a lid with nipple housing for the child to suckle from. The lid with nipple screws onto the bottle portion and seals the liquid inside. The bottle portion is intended to contain liquids, such as infant formula, breast milk expressed from the child's mother via breast pump, cow, rice, or soy milk, or any variety of juice. As in the pacifier market, differing manufacturers of infant bottles produce different shapes of bottles and nipples. The purpose of having differing shapes available on the market is for consumer convenience because some shapes of bottles are easier for the infant or caregiver to hold, and some are more comfortable for the infant when some shapes of bottles are touted to prevent the infant from swallowing as much air, reducing painful gas. Also, different infants have different preferences for nipple shapes, just as they do for pacifier nipples.

Because breast milk and formula are heated before given to an infant via bottle, there is the danger of overheating the milk or formula and burning the child's mouth, throat, tongue, or gums at each feeding. Parents often test the temperature of the contents of any bottle with their hand to the side of the bottle, or by expressing some of the contents onto their wrist before feeding. But, the parent or caregiver may not be as sensitive to temperature as a newborn, baby, or teething infant who has very sensitive spots in his/her mouth. The parent or caregiver may even forget to test the bottle contents at each feeding, especially when they are exhausted in the middle of the night. Parents feel more at ease to know a babysitter is using a back-up safety device such a temperature indicator instead of just using their hand or wrist.

Many of the available baby bottles are not effective in accurately providing information about the temperature of the liquid inside the bottle. The most suitable and comfortable temperature for the heated content of a baby bottle for an infant is between about 35 to 38 degrees Celsius, where liquids below 35 degrees Celsius may bee too cold for the comfort of the infant, and temperatures above 38 degrees Celsius may be too hot and even dangerous for the infant.

While there has been a trend to produce more effectively constructed baby bottles in this regard, further improvements in effectiveness, convenience, and safety in heated baby bottles with temperature indicators are desirable, and the present invention addresses the existing problems and provides related solutions and benefits.

### SUMMARY OF THE INVENTION

The present invention relates generally to the field of methods and devices for preparation of a baby bottle, cup, mug, or the like containing a heated liquid having a proper temperature, and particularly to methods and devices including a thermochromatic ink that changes color above the comfort zone of the infant. The present invention is particularly adaptable as an addition to any baby bottle of evaluation of the temperature of the heated liquid inside the baby bottle before feeding the infant.

The present invention recognizes that the ability to accurately evaluate the temperature of a heated liquid inside a baby bottle may be done in a more effective, convenient, and safe way by providing a baby bottle having an elastic band including at least one thermochromatic ink able to change color at temperatures above the comfort zone the infant.

A first aspect of the present invention includes a method of preparing a bottle, cup, mug, or the like containing a heated liquid of proper temperature for an infant, comprising the steps of: a) providing a baby bottle comprising a cylindrical container portion capable of containing a heated liquid, and optionally a lid portion comprising a nipple housing for an infant to suckle from, wherein the cylindrical container portion and the lid portion are able to be reversibly attached to each other; b) providing an elastic band comprising at least one thermochromatic ink able to change color at temperatures above the comfort zone the infant, the elastic band being able to be stretched and fit around the cylindrical container portion of the baby bottle; and c) attaching the elastic band around the cylindrical container portion of the baby bottle, wherein a color change in the elastic band indicates the temperature of the heated liquid inside the baby bottle to be above the comfort zone of the baby.

A second aspect of the present invention includes a device for evaluating the temperature of a heated liquid inside a baby bottle, cup, mug, or the like including: an elastic band comprising at least one thermochromatic ink able to change color at temperatures above the comfort zone the infant, the elastic band being able to be stretched and fit around the cylindrical container portion of a baby bottle, wherein a color change in the elastic band indicates the temperature of the heated liquid inside the baby bottle to be above the comfort zone of the baby.

### BRIEF DESCRIPTION OF THE DRAWINGS

FIG. 1 shows a perspective view of a unitary elastic band comprising a thermochromatic ink for evaluating the temperature of a heated liquid inside a baby bottle.

FIG. 2 shows a top view of a non-unitary elastic band comprising a thermochromatic ink for evaluating the temperature of a heated liquid inside a baby bottle.

### DETAILED DESCRIPTION OF THE INVENTION

### Introduction

The present invention recognizes that the ability to accurately evaluate the temperature of a heated liquid inside a baby bottle, cup, or mug may be done in a more effective, convenient, and safe way by providing a baby bottle having an elastic band including at least one thermochromatic ink able to change color at temperatures above the comfort zone the infant.

As a non-limiting introduction to the breadth of the present invention, the present invention includes several general and useful aspects, including:
1) A method of preparing a baby bottle containing a heated liquid of proper temperature for an infant, comprising the steps of:
a) providing a baby bottle comprising a cylindrical container portion capable of containing a heated liquid, and optionally a lid portion comprising a nipple housing for an infant to suckle from, wherein the cylindrical container portion and the lid portion are able to be reversibly attached to each other;
b) providing an elastic band comprising at least one thermochromatic ink able to change color at temperatures above the comfort zone the infant, the elastic band being able to be stretched and fit around the cylindrical container portion of the baby bottle; and
c) attaching the elastic band around the cylindrical container portion of the baby bottle, wherein a color change in the elastic band indicates the temperature of the heated liquid inside the baby bottle to be above the comfort zone of the baby.
2) A device for evaluating the temperature of a heated liquid inside a container, including: an elastic band comprising at least one thermochromatic ink able to change color at temperatures above the comfort zone the infant, the elastic band being able to be stretched and fit around the cylindrical container portion of a baby bottle, wherein a color change in the elastic band indicates the temperature of the heated liquid inside the baby bottle to be above the comfort zone of the baby.

Further objectives and advantages of the present invention will become apparent as the description proceeds and when taken in conjunction with the accompanying drawings. To gain a full appreciation of the scope of the present invention, it will be further recognized that various aspects of the present invention can be combined to make desirable embodiments of the invention.

Unless defined otherwise, all technical and scientific terms used herein have the same meaning as commonly understood by one of ordinary skill in the art to which this invention belongs. Where a term is provided in the singular, the inventor also contemplates the plural of that term. The nomenclature used herein and the procedures described below are those well known and commonly employed in the art.

### I. Methods and Devices for Preparing a Container Containing a Heated Liquid of Proper Temperature for an Infant

The present invention includes methods and devices of preparing a bottle, cup, mug, or the like containing a heated liquid of proper temperature for an infant. The methods of the present invention include providing a baby bottle, cup, mug, or the like having a cylindrical container portion capable of containing a heated liquid, and optionally a lid portion comprising a nipple housing for an infant to suckle from, wherein the cylindrical container portion and the lid portion are able to be reversibly attached to each other. Any suitable baby bottle, cup, or mug, with or without handles and with or without a lid may be utilized for the present invention, what is important for the present invention is that the baby bottle, cup, mug, or the like be made of a material that allows thermal conduction of the heat of the liquid inside the bottle to the outer surface of the bottle's container.

The methods and devices of the present invention also include providing an elastic band including at least one thermochromatic ink on or within the elastic band that is able to change color at temperatures above the comfort zone the infant. The elastic band of the present invention may be able to be stretched and fit around the cylindrical container portion of the baby bottle. Any thermochromatic ink of any color that is suitable for the purpose may be used. Thermochromatic inks where a color change occurs at or near a certain specific temperature are available for a wide range of temperatures. Thermochromatic inks may be in the form of a liquid, powder, or solid that can be used in the present invention. A wide range of thermochromatic inks, such as for example thermochromatic inks and powders are available from Chromazone® in the US, UK, Canada, and Mexico.

The elastic band of the present invention may be of a unitary construction, similar to a circular rubber band that is able to be stretched and fitted and attached around the container portion of the baby bottle over the area where heated liquid is contained. The elastic band may also be of a non-unitary construction, similar to a belt that is able to elastically encircle and be fitted and reversibly attached around the container portion of the baby bottle over the area where heated liquid in contained. In the case of the elastic band having non-unitary construction, the first and second ends of the non-unitary elastic band may be attached to each other by any suitable reversibly attachment means, such as for example, adhesive or hook and loop fasteners including velcro-type hook and loop fasteners. It is important that the elastic band be place over the bottle where the heated liquid is contained so that thermal conduction can conduct the heat of the liquid inside the bottle to the elastic band of the present invention. A color change in the elastic band indicates the temperature of the heated liquid inside the baby bottle to be above the comfort zone of the baby. As the most suitable and comfortable temperature for the heated content of a baby bottle for an infant is between about 35 to 38 degrees Celsius, a thermochromatic ink may be used wherein a change in color occurs at or above 38 degrees Celsius. The elastic band may include the thermochromatic ink throughout the entire elastic band so that the entire elastic band is able to change color at or about a certain temperature, or the elastic band may include the thermochromatic ink in one or more potions of the elastic band so that only part of the band is able to change color at or about a certain temperature. For example on a part of the band may include the thermochromatic ink in the form of letters, such as the word HOT or various shapes or figures.

The present invention also includes kits, including the thermochromatic ink containing elastic band of the present invention along with a baby bottle, cup, mug, or the like in a kit or package.

### EXAMPLES

### Example I

### A Devices for Preparing a Container Containing a Heated Liquid of Proper Temperature for an Infant

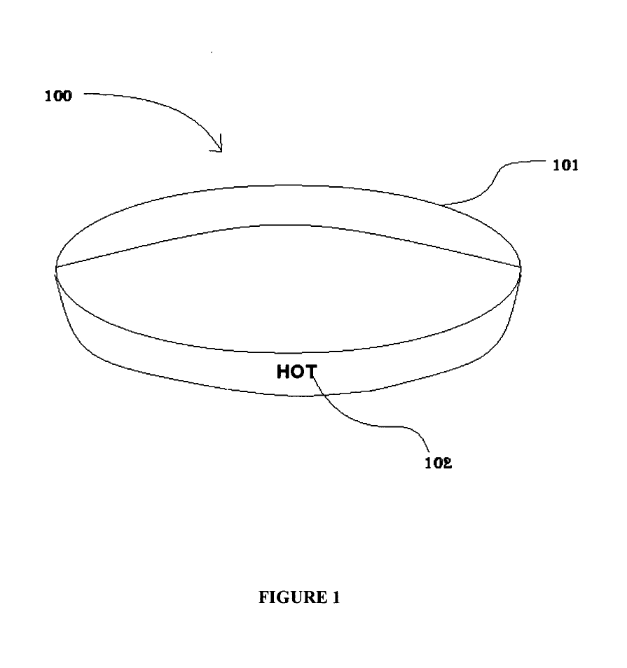

Referring to FIGS. 1, this Example provides an embodiment of a device 100 for preparing a bottle, cup, or mug containing a heated liquid of proper temperature for an infant includes a unitary elastic band 101 including at least one thermochromatic ink 102 included on or within the elastic band in the form of the word HOT. The thermochromatic ink 102 being able to change color at temperatures above 38 degrees Celsius. The elastic band 101 being able to be stretched and fit around the cylindrical container portion of the baby bottle.

### EXAMPLE II

### A Devices for Preparing a Container Containing a Heated Liquid of Proper Temperature for an Infant

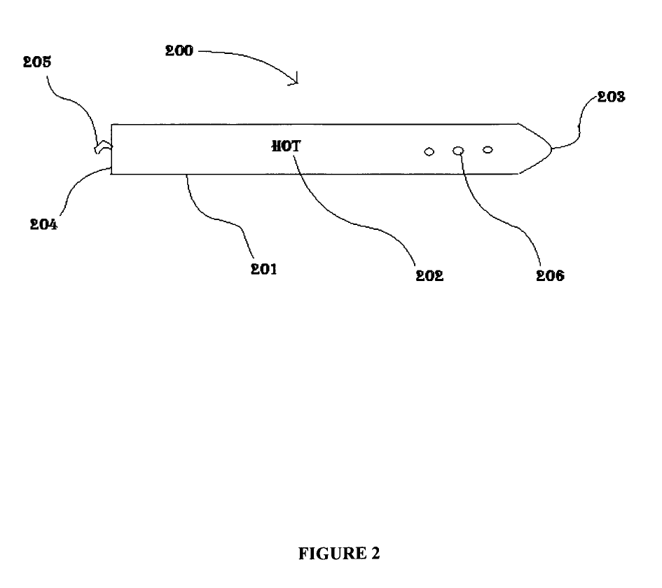

Referring to FIGS. 2, this Example provides an embodiment of a device 200 for preparing a bottle, cup, or mug containing a heated liquid of proper temperature for an infant includes a non-unitary elastic band 201 including at least one thermochromatic ink 202 included on or within the elastic band in the form of the word HOT. The thermochromatic ink 202 being able to change color at temperatures above 38 degrees Celsius. The elastic band 201 includes a first end region 203 and a second end region 204 that are able be attached to each other by any suitable reversibly attachment means that is a hook 205 and loop 206 fastener in this Example.

All headings are for the convenience of the reader and should not be used to limit the meaning of the text that follows the heading, unless so specified. Various changes and departures may be made to the present invention without departing from the spirit and scope thereof. Accordingly, it is not intended that the invention be limited to that specifically described in the specification or as illustrated in the drawings, but only as set forth in the claims. Although the invention has been described and illustrated with respect to exemplary embodiments thereof, it should be understood by those skilled in the art that the foregoing and various other changes, omissions, and additions may be made therein and thereto, without parting from the spirit and scope of the present invention.

What is claimed is:

1. A method of preparing a container containing a heated liquid of proper temperature for an infant, comprising the steps of:
a) providing a container comprising a cylindrical container portion capable of containing a heated liquid, and optionally a lid portion comprising a nipple housing for an infant to suckle from, wherein said cylindrical container portion and said lid portion are able to be reversibly attached to each other;
b) providing an elastic band comprising at least one thermochromatic ink able to change color at temperatures above the comfort zone the infant, said elastic band being able to be stretched and fit around said cylindrical container portion of said container; and
c) attaching said elastic band around said cylindrical container portion of said container, wherein a color change in said elastic band indicates the temperature of the heated liquid inside said container to be above the comfort zone of the baby.

2. The method of claim 1, wherein said thermochromatic ink changes color above 38 degrees Celsius.

3. The method of claim 1, wherein said thermochromatic ink comprises letters or shapes.

4. The method of claim 3, wherein said letters or shapes comprise the word HOT.

5. The method of claim 1, wherein said elastic band comprises a unitary ring.

6. The method of claim 1, wherein said elastic band comprises a strip comprising a first end region and a second end region, further wherein said first end region is capable being reversibly attached to said second end region and wrapped around said cylindrical container portion of said container.

7. The method of claim 6, wherein said first end region reversibly attaches to said second end region by way of an adhesive.

8. The method of claim 6, wherein said first end region reversibly attaches to said second end region by way of one or more hook and loop fasteners.

9. A device for evaluating the temperature of a heated liquid inside a container, comprising:
an elastic band comprising at least one thermochromatic ink able to change color at temperatures above the comfort zone the infant, said elastic band being able to be stretched and fit around a cylindrical container portion of a container, wherein a color change in said elastic band indicates the temperature of the heated liquid inside said container to be above the comfort zone of the baby.

10. The method of claim 9, wherein said thermochromatic ink changes color above 38 degrees Celsius.

11. The method of claim 9, wherein said thermochromatic ink comprises letters or shapes.

12. The method of claim 11, wherein said letters or shapes comprise the word HOT.

13. The method of claim 9, wherein said elastic band comprises a unitary ring.

14. The method of claim 9, wherein said elastic band comprises a strip comprising a first end region and a second end region, further wherein said first end region is capable being reversibly attached to said second end region and wrapped around said cylindrical container portion of said container.

15. The method of claim 14, wherein said first end region reversibly attaches to said second end region by way of an adhesive.

16. The method of claim 14, wherein said first end region reversibly attaches to said second end region by way of one or more hook and loop fasteners.

17. A kit, comprising:
a) a container comprising a cylindrical container portion capable of containing a heated liquid, and optionally a lid portion comprising a nipple housing for an infant to suckle from, wherein said cylindrical container portion and said lid portion are able to be reversibly attached to each other; and
b) an elastic band comprising at least one thermochromatic ink able to change color at temperatures above the comfort zone the infant, said elastic band being able to be stretched and fit around said cylindrical container portion of said container.

18. The kit of claim 17, wherein said elastic band comprises a unitary ring.

19. The kit of claim 17, wherein said elastic band comprises a strip comprising a first end region and a second end region, further wherein said first end region is capable being reversibly attached to said second end region and wrapped around said cylindrical container portion of said container.

20. The kit of claim 19, wherein said first end region reversibly attaches to said second end region by way of an adhesive or one or more hook and loop fasteners.
